(19) United States
(12) Patent Application Publication
(10) Pub. No.: US 2026/0320224 A1
(43) Pub. Date: Oct. 15, 2026

(54) SYSTEM AND METHOD FOR CREATING, STORING, SAVING, MANAGING, TAGGING, COLLECTING, ORGANIZING, ASSIGNING, SHARING AND/OR TRANSFERRING INFORMATION WITHIN THE SYSTEM ITSELF WHEN NO LONGER AN ACTIVE USER, OR WITH A HIGHLY SECURE VIRTUAL VAULT, AVATAR OR ANDROID

(71) Applicants: Agustin VELÁZQUEZ GARCÍA-LOPEZ, Mérida, Yacatán (MX); Joaquin ALCOCER ÁVILA, Mérida, Yacatán (MX); Osvaldo VELÁZQUEZ MONTES, Chicxulub Pueblo, Yucatán (MX); Antonio Ulises COBÁ UC, Mérida, Yacatán (MX)

(72) Inventors: Agustin VELÁZQUEZ GARCÍA-LOPEZ, Mérida, Yacatán (MX); Joaquin ALCOCER ÁVILA, Mérida, Yacatán (MX); Osvaldo VELÁZQUEZ MONTES, Chicxulub Pueblo, Yucatán (MX); Antonio Ulises COBÁ UC, Mérida, Yacatán (MX)

(21) Appl. No.: 19/105,454

(22) PCT Filed: Aug. 18, 2023
(86) PCT No.: PCT/IB2023/058300

§ 371 Date: Feb. 21, 2025

(30) Foreign Application Priority Data
Aug. 22, 2022 (MX) MX/A/2022/010397

(51) Int. Cl. G06F 21/62; G06T 13/40; G10L 13/08

(52) U.S. Cl. CPC G06F 21/6245; G06T 13/40; G10L 13/08

(57) ABSTRACT

Systems and methods for creating, storing, saving, managing, tagging, collecting, organizing, assigning, sharing and/or transferring information within the system itself to virtual vaults, avatar or android generating systems or other digital or physical devices. The digital content is hosted on the system and/or in one or more highly secure virtual vault(s) of a user and is assignable, shared, or transferred to previously defined users who are related to or by the initial user, which allows the information contained in the vault to feed an artificial intelligence that learns from the user. The artificial intelligence is prepared with user-generated criteria to act in the administration of trusts or other legal vehicles to manage, assign, or share information within the system itself, virtual vaults or systems that generate digital, virtual, or physical avatars.

### FIELD OF THE INVENTION

The present invention relates to systems and methods for creating, storing, saving, managing, tagging, collecting, organizing, assigning, sharing and/or transferring information within the system itself to virtual vaults, avatar or android generating systems or other digital or physical devices, including all kind of digital content, but not limited to, audio files, photographic files, video files, text files, personal information, classified information, confidential information or any other type of information. The digital content is hosted on the system and/or in one or more highly secure virtual vault(s) of a user and is assignable, shared or transferred to previously defined users and who are related to or by the initial user, which allows the information contained in the vault to feed an artificial intelligence that learns from the user, his environment or the information provided by the user himself and with which this artificial intelligence can interact with one or more additional users by means of a physical or digital avatar, which will exist in an exclusive and restricted metaverse in terms of obtaining information from other unauthorized users. In addition, the artificial intelligence is prepared with user-generated criteria to act in the administration of trusts or other legal vehicles to manage, assign or share information within the system itself, virtual vaults or systems that generate digital, virtual, or physical avatars.

### BACKGROUND OF THE INVENTION

With the creation and use of electronic devices and applications that are used through them, human beings generate and use a large amount of information contained in their devices such as: photographs, videos, passwords, accounts of different applications, audio files, text files, even information that is not generated in electronic media but that can be stored through the use of them, such as personal information, confidential information, wherein the content of the files can include ideas, suggestions, thoughts, experiences, advice, nostalgic moments, reproaches, regrets, etc.

At some point in life, human beings need to save and securely store all this information so that it can be transferred, shared, and inherited to loved ones and/or those previously designated or chosen to review it after their death.

In addition, when a human being dies, their loved ones, whether family members, friends, co-workers, employees, among others, feel the need to continue communicating with the person, either to continue interacting or to receive and obtain information that was stored in life and that is available for consultation if previously authorized by the user. This communication can take place through electronic devices or in a virtual world, such as the metaverse, even in the physical world with any device, including androids, as long as the person is no longer available in physical form in the world we know, but only in the virtual-digital world.

On the other hand, human beings have the need to maintain the privacy of their information and its safekeeping in these times in which the information safeguarded and accessed through the internet is taken and used to activate marketing strategies, in the best of cases.

Thus, there is currently no system and method that allows, through the use of a physical or digital avatar in an electronic device or in a virtual reality world or metaverse, a user to inherit one or more persons and others to receive information contained in a virtual vault created from digital content by a user who has died, the user or designees may have a coexistence with the avatar that was fed and even continue to feed on the information recorded by the user during his or her lifetime, or third parties who interact with that avatar, within the metaverse and this information is orderly delivered or shared on one occasion or several occasions, to the heirs or designees, in an experiential format or formats of interaction, as if it were still alive, sometimes with messages expressly addressed to a person or group of persons previously selected or authorized to receive and interact with the information of the avatar, being that these designated third parties interact virtually, digitally or also by means of their own avatar with that avatar, information stored in the vault, even with an android in the physical world.

Now, with respect to the prior art, US 20200245954 A1 discloses systems and methods for displaying the appearance of a user by adding the user as an avatar in a health and fitness program. The system includes components configured to receive information related to the user's physical appearance and also to receive information about the user's health and fitness. The system also includes components for determining or predicting changes in the user's physical appearance based on a physical exercise program of the user and based on the user's health. The system includes a visualization component configured to generate the user's avatar based on the information entered and the changes in appearance that are determined or predicted. However, this document does not disclose the interaction of the user's avatar with another user or users, avatars, or androids in order to transfer, interact, receive, or provide information.

US 20210043188 A1 discloses a commemorative avatar. The avatar may include characteristics of a first user such as his voice characteristics. The invention discloses generating a digital voice based on the characteristics of the user's voice. The invention also includes receiving information from a second user. The invention discloses communication between the memorial avatar and the second user using the digital voice. However, this document does not disclose the possibility of transferring, interacting, receiving and/or providing information contained in a user vault via the memorial avatar to a pre-designated person or group of persons with structured and sometimes specially directed messages to that person or persons, much less interacting between avatars in the virtual world or androids in the physical world.

US20190156222 A1 discloses systems, methods and apparatus implemented in an Al-enabled device that is capable of developing a personality of its own and having dialogues and conversations. The Al-enabled device can determine responses to stimuli based on user profiles and personality profiles that have been developed through interaction with users and inputs of data and information. However, this document does not disclose the possibility of storing, sharing, transferring, and providing information contained in a vault from one user to another or others previously designated, authorized or selected, related to the avatar or android.

KR20040014123 A discloses a system that captures the expression of emotions and implements them in a virtual personality (avatar). The virtual personality is capable of expressing a previously analyzed emotion as an operation by analyzing the emotion included in input data or natural language data. The system calculates a strength of the emotion based on an analysis of the input data. The system includes an image information input unit that receives characteristics for a virtual personality image (avatar) from a user and creates the virtual personality (avatar) based on the received information. The system can create a dynamic virtual personality (avatar) based on the analyzed image information and emotions. However, this document does not disclose the possibility of transferring and providing information contained in a vault to a user or users related to the avatar or android.

US20220014352 A1 relates to systems and methods for enabling the creation, collection, selection and organization, either in a guided or automated manner, of items of digital content representing a user's legacy, interaction, personality, and experiences. In this invention a digital rights manager is assigned to control access to the content after the death of the user. In this invention, the user can create an archive with content that is to be managed in a specific manner after his or her death. As an example, the created file can be handed over to a family member or can be deleted from the system after the user's death. The content of the file must be secured or encrypted before access to them is allowed. The invention also discloses the use of Artificial Intelligence to act on behalf of the user to create, share and publish content on social media or digital platforms. However, this document does not consider a disclosure by artificial intelligence, as the core of the present invention is that all information, personal and character and management information of the avatar or android of the initial user or owner is for exclusive use, i.e. that no one outside of him and in due course of his recipients or designees can access that information if they have not been previously authorized or the information allowed to be issued by an android. This also considers that the interactions can or will be (depending on the information provided by the user to the AI) different for each recipient or designee, or in groups. It is also considered, unlike the aforementioned document, that the information should be assigned from the conception of this, even adding other users or receivers, so that a digital administrator would not be required, but by means of configuration and validation, the previous assignments to the receivers or designees would be made. On the subject of artificial intelligence, it is considered for an interaction with the recipient or designee, after the death of the original user or owner, so it can play sounds and a full-body avatar that can live in the metaverse as well as serve for the configuration of a hardware human or android representation. Such information can also continue to be assigned infinitely from one owner user to others, as long as the recipient of the information has such powers.

As will be seen from the above documents, the prior art does not provide the possibility to create a virtual vault of a first user and an avatar, android for that first user containing the virtual vault, so that after the death of the original user or subsequent users if so authorized, the information contained in the vault can be assigned to another user or users, wherein the information can be assigned directly or can be obtained by interaction with the user's avatar in an infinite form.

The documents that make up the prior art do not solve the problem of being able to assign information contained in a virtual vault infinitely and to do so through the use of an avatar in an electronic or android device, either in a virtual reality world, such as the metaverse, or to serve as a basis for the configuration of a personal and exclusive hardware for each designee.

By virtue of the above, it has been sought to remove the drawbacks of the prior art by developing a system and method that allows for storing, collecting, creating, organizing, sharing and interacting with digital content, including, but not limited to, audio files, photographic files, video files, text files, personal information, classified information, confidential information, which may contain experiences, recommendations, advices, regrets, etc. The digital content is used to generate a highly secure virtual vault of a user that is assignable and that allows the retrieval of information contained in the vault through the interaction of one or more additional users with an avatar, which may be hosted on an electronic device or in the metaverse, and the avatar may form part of the legal vehicle for the processing of such information wherein there is an acknowledgement or acceptance of the involvement of artificial intelligence in human decision making.

The system and method of the present invention can perform various functions through external servers known or to be known, and through the use of artificial intelligence technology, Internet of Things and/or blockchain which generate in this invention the status of “Blended Technologies”.

Thus, the system and method of the present invention solves the problem of being able to allocate information contained in a virtual vault in a unique or infinite form and to do so through the use of an avatar in an electronic device or in a virtual reality world, such as the metaverse, including through the use of an android or android in the physical world.

### OBJECT OF THE INVENTION

The object of the present invention is to provide a system and method for creating and managing a highly secure virtual vault. Such a vault is created by a first user by storing, collecting, creating, organizing and sharing digital content, including, but not limited to, audio files, photographic files, video files, text files, personal information, classified information, confidential information, wherein the content of the files may include ideas, suggestions, thoughts, experiences, advices, nostalgic moments, reproaches, regrets, among others.

An additional object of the present invention is to provide a system and method for creating an avatar, associated with the user creating the vault, through the use of artificial intelligence technology, capable of interacting with a user or users previously designated, assigned or authorized by the initial user or owner by mimicking the behavior of the user creating the vault.

An additional object of the present invention is to provide a system and method that allows the use of the avatar in an electronic device and to connect with other devices for information consultation, delivery and even interaction between a person and the avatar, between avatars or avatar and android.

An additional object of the present invention is to provide a system and method to enable the use of the avatar in a virtual reality world, such as the metaverse, or to interact in the physical world with an android or android.

It is another object of the present invention to provide a system and method for conducting a protocol for identifying that the user creating the vault has died.

It is another object of the present invention to provide a system and method for assigning vault information in accordance with management or assignment instructions previously established by the user creating the vault.

An additional object of the present invention is to provide a system and method that allows interaction of the avatar with all users who have access to information within the system having the possibility to configure uniquely for each assignee for interaction or with a multiplicity of these.

An additional object of the present invention is to provide a system and method that allows another user of the system to access information contained in the virtual vault indefinitely.

It is another object of the present invention to provide a system and method so that, through interaction of the avatar with another user of the system, the latter can obtain information contained in the virtual vault and interact indefinitely.

It is a further object of the invention that the information provided to the artificial intelligence can be used to configure a virtual avatar within the metaverse and a physical avatar that interacts with it or its designated persons or heirs and that can access the information in the physical world with any type of device, including an android.

### BRIEF DESCRIPTION OF THE INVENTION

The system to create, store, save, manage, tag, collect, organize, assign, share and/or transfer information through a highly secure virtual vault and an avatar consists of a digital vault with the ability to assign information after the death of the owner user. This information will be taught to an artificial intelligence that will receive and communicate information by means of text, voice, and images of the owner's face. This artificial intelligence will be used to control an avatar of the owner user with which the assignment users will be able to interact in a metaverse environment, in which the assignment user will be able to visit the vault, as well as other virtual facilities such as banks, offices and entertainment areas, among many other possibilities. The vault will be hosted in a remote server configuration for flexible processing capacity depending on the demand received and with communication by a blockchain server structure with flexibility of growth, which is connected through an application programming interface (API), a globalized database, which collects data from the decentralized information blocks of this, in which there is a validation access to increase the security of the information contained.

### BRIEF DESCRIPTION OF THE DRAWINGS

FIG. 1 shows a diagram depicting the structure of servers that make up the system for creating, storing, saving, managing, managing, tagging, collecting, organizing, allocating, sharing and/or transferring information using a highly secure virtual vault and an avatar of the present invention.

FIG. 2 shows a validation process of assigned/designated users.

FIG. 3 shows a diagram of access to the modules that make up the virtual vault.

FIG. 4 shows a flow chart of the death confirmation protocol steps in accordance with one embodiment of the present invention.

FIG. 5 shows a flowchart of the steps of a data feed process for artificial intelligence in accordance with one embodiment of the present invention.

FIG. 6 shows a diagram depicting the steps comprising the method for creating, storing, storing, storing, managing, managing, tagging, collecting, organizing, allocating, sharing and/or transferring information using a highly secure virtual vault and an avatar of the present invention.

### DETAILED DESCRIPTION OF THE INVENTION

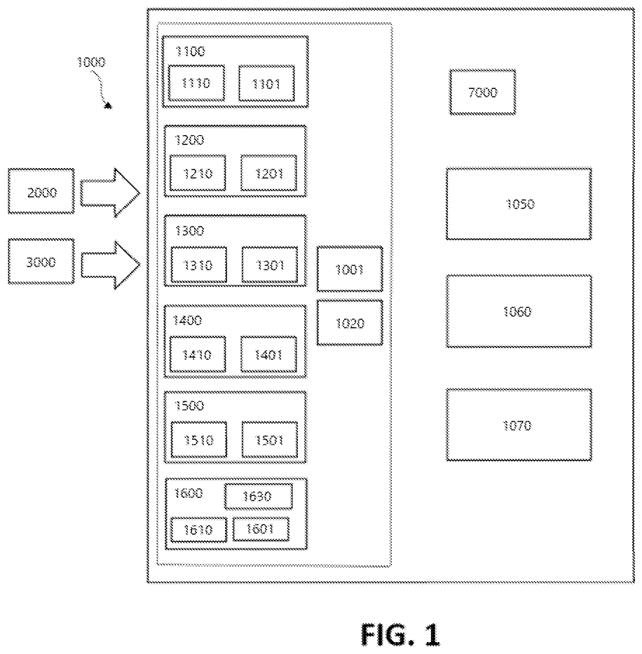

Referring to FIG. 1, FIG. 1 shows a first embodiment of a system (1000) for creating, storing, storing, storing, managing, managing, tagging, collecting, collecting, organizing, allocating, sharing and/or transferring information by means of a highly secure virtual vault comprising a virtual vault as the core of this invention and having the objective of providing a main user with safeguarding, in a memory unit (1101, 1201, 1301, 1401, 1501, 1601) of digital files, such as documents, images, photographs, videos and recordings, including all kinds of life information that is generally lost, not stored, not shared. The main user can access the virtual vault system (1000) from a main main user device (2000), which can be, but is not limited to, a mobile phone, tablet device, personal computer, or laptop computer, or the metaverse and virtual vault itself.

The virtual vault system (1000) comprises six modules (1100, 1200, 1300, 1400, 1500, 1600) with different approaches for the main user to create, store, save, manage, tag, collect, organize, allocate, share and/or transfer their information in a memory unit (1101, 1201, 1301, 1401, 1501, 1601) and thereby also capture information for an artificial intelligence system (1050, 1060) of the invention. The modules (1100, 1200, 1300, 1400, 1500, 1600) comprising the virtual vault system (1000) of the present invention are described below.

To enter the virtual vault system (1000), the main user registers by means of the user device (2000) by filling in a form from a web portal or a mobile application of the system, or within the virtual vault system (1000) in a metaverse (1070), the registration is done by entering their general contact details and registering a password and the registration of their biometric data for future identity validations. This registration data is stored in a general memory unit (1001) of the virtual vault system (1000). As shown in FIG. 1, from the registration through the user device (2000), the user will have visibility and access to the management of their information from a conventional environment, however in the hosting of this an access contract is generated, since there will be a blockchain structure (or blockchain, commonly known), which consists of the division of data into different blocks that require validation of the personality of the person requesting access to these data and these are managed from an Application Programming Interface (API), which will manage access to these blocks and the identification of the entity or user requesting them, this according to the contract generated in the user's record. All of the above will have an event log and with which an activity base will be formed and stored in the general memory unit (1001), with which it will be possible to consult the context of the queries. Also considered in the registration process is the opportunity to acquire a license for the full or partial use of the invention. As part of the registration, the main user, via the user device (2000) will have the ability to choose, either at that time or at a later time, to integrate, assign other users of the virtual vault system (1000), add other users of the system (1000) over time or remove them, who may be assigned access to, or transfer, via a user device (3000) any information recorded by the main user in the virtual vault system (1000), or restrict or delete it, either in general or individually for each assigned user. In addition, the main user, by means of the user device (2000), may choose more than one assigned user.

The connection between the user devices (2000, 3000) and the virtual vault system (1000) is made through the use of a network, either wired or wireless, using connection protocols such as Internet, Ethernet, among others.

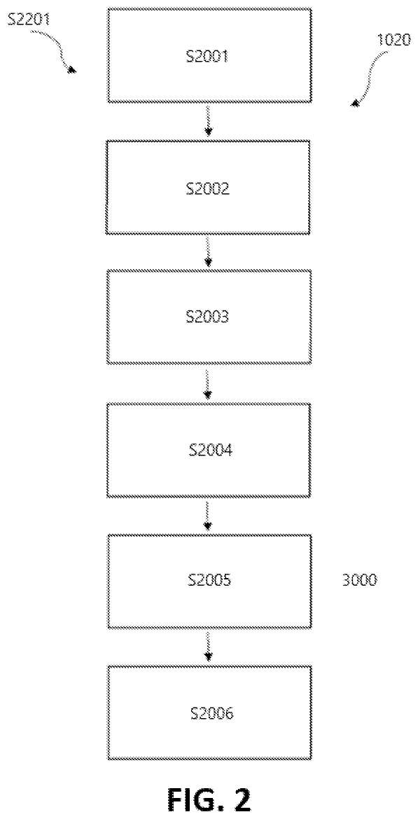

According to a second embodiment of the present invention, the virtual vault system (1000), in order to maintain the high level of security between users, the system comprises an assignment module (1020) configured to assign, by the main user, one or more assigned users, and which provides a validation process of the assigned user personality through the process described in FIG. 2. This will be done, by means of the user devices (2000, 3000) and the assignment module (1020), by registering an assigned user account by the main user, placing the general data and contact data of the assigned user, which are stored in the general system memory (1001). Based on the data entered by the main user corresponding to the assigned user, the main user selects a point of contact and one or more data to be validated by the assigned user. Once the registration of the assigned user by the owner user is completed, the assignment module (1020) sends an invitation to the assigned user device (3000), to validate the registration of the assigned user, this invitation is received and opened in the assigned user device (3000), the validation data is placed on a validation page of the virtual vault system (1000) and thereby activates the option for the owner user to assign information stored in the memory units (1101, 1201, 1301, 1401, 1501, 160) of the different modules (1100, 1200, 1300, 1400, 1500, 1600) of the virtual vault system (1000) corresponding to the main user that can be known by and transferred to the assigned user until the demise of the owner user. Thus, once the death of the main user has been confirmed, the information stored in the memory units (1101, 1201, 1301, 1401, 1501, 1601) by the main user in the virtual vault system (1000) is transferred to the memory units (1101, 1201, 1301, 1401, 1501, 1601) corresponding to the assigned user.

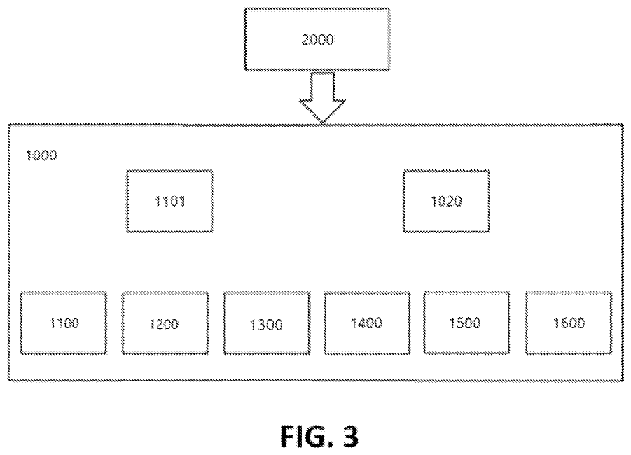

According to a further embodiment of the invention, the virtual vault system (1000) provides access to the main user, via the main user device (2000), to the modules (1100, 1200, 1300, 1400, 1500, 1600) of the system (1000) as shown in FIG. 3. The main user, with prior registration as explained above, may enter any of the modules (1100, 1200, 1300, 1400, 1500, 1600) of the virtual vault system (1000). This access by the main user will be unique and all the material he/she generates from the invention or stores there, will be encrypted as mentioned above and cannot be known by any unauthorized person, through the allocation module (1020), as described above.

Referring again to FIG. 1, the virtual vault system (1000) comprises a Legacy Life Module (1100) configured to create, store, save, manage, tag, collect, organize, assign, share and/or transfer information including, but not limited to, audio files, photographic files, video files, text files, personal information, classified information, confidential information. Additionally, the life legacy module (1100) is configured to allow the main user, via the device (2000) to register their posthumous will, using any of the above-mentioned documents, as well as information necessary to execute their will such as contacts for banking, insurance and follow-up care to execute the care of the shared information and the destination of the same by the delegate or authorized party. All this by capturing a text, video, or voice recording, as well as uploading a file by loading it into a memory unit (1101) of the life legacy module (1100). The life legacy module (1100) further comprises a generation module (1110) configured to allow the main user to generate content that they wish their loved ones to know and remember, such content can be generated in any of the above-mentioned document formats and stored in the memory unit (1101). In this module (1100) are integrated the functionalities for understanding information generated or discharged in the invention, as described above, to feed the artificial intelligence, which will programmatically request information and incentives for the generation of this content or information by means of notifications with suggestions for content to be uploaded or general. Text files, images, PDF, voice, video, experiences, etc., can be integrated in an enunciative but not limiting way. Either at the time of generation, through the generation module (1110) and/or the storage of the files in the memory unit (1101) with the information, the owner user will have the opportunity to assign, through the assignment module (1020) one or more assigned users to share this information at the time of his death.

Each generated and/or stored file shall be individually assigned to an assigned user by means of the assignment module (1020).

Once the death of the main user is confirmed, the information stored in the memory (1101) for the main user and identified as assigned to an assigned user by the assignment module (1020) is transferred to the memory unit (1101) of the legacy life module (1100) corresponding to the assigned user.

Referring again to FIG. 1, the virtual vault system (1000) comprises a financial legacy module (1200) configured to create, store, save, manage, tag, collect, organize, assign, share and/or transfer information including, but not limited to, audio files, photographic files, video files, text files, personal information, classified information, confidential information.

This module (1200) is configured to store, in a memory unit (1201), the documents and information necessary to access all financial resources, be it bank accounts in different parts of the world, life insurance, medical expenses, investments, property titles, promissory notes and other financial instruments relevant to the main user. These documents that are stored in the memory unit (1201) are integrated, but not limited to, in the form of text, image, PDF, voice, video, etc. files. This is done by capturing a text, video, or voice recording, as well as uploading a file by loading it into the memory unit (1201). The financial legacy module (1200) further comprises a generation module (1210) configured to allow the main user to generate content that they wish their loved ones to know and remember, such content can be generated in any of the aforementioned document formats and stored in the memory unit (1201). This module (1200) integrates the functionalities for the understanding of the information generated or discharged in the invention, as described above, to feed the artificial intelligence, which will programmatically request information and incentives for the generation of this content or information by means of notifications with suggestions for content to be uploaded or general. Text files, images, PDF, voice, video, experiences, etc., can be integrated in an enunciative but not limiting way. Either at the time of generation, through the generation module (1210) and/or the storage of the files in the memory unit (1201) with the information, the owner user will have the opportunity to assign, through the assignment module (1020) one or more assigned users to share this information at the time of their death.

Each generated and/or stored file shall be individually assigned to an assigned user by means of the assignment module (1020).

Once the death of the main user is confirmed, the information stored in the memory (1201) for the main user and identified as assigned to an assigned user by the assignment module (1020) is transferred to the memory unit (1201) of the legacy life module (1200) corresponding to the assigned user.

Referring again to FIG. 1, the virtual vault system (1000) comprises a social legacy module (1300) configured to create, store, save, manage, tag, collect, organize, assign, share and/or transfer information including, but not limited to, audio files, photographic files, video files, text files, personal information, classified information, confidential information.

This module (1300) is configured to allow users to integrate their forms of access and contact with their social environments, such as access to social networks, chat conversations and voice recordings, social and sports club registrations, lodge, and community memberships, etc. All this by capturing a text, video, or voice recording, as well as uploading a file by loading it into a memory unit (1301) of the social legacy module (1300). The social legacy module (1300) further comprises a generation module (1310) configured to allow the main user to generate content that they wish their loved ones to know and remember, such content can be generated in any of the above-mentioned document formats and stored in the memory unit (1301). This module (1300) integrates the functionalities for the understanding of the information generated or registered in the invention, as described above, to feed the artificial intelligence, which will programmatically request information and incentives for the generation of this content or information by means of notifications with suggestions for content to be uploaded or in general. Text files, images, PDF, voice, video, experiences, etc., can be integrated in an enunciative but not limiting way. Either at the time of generation, through the generation module (1310) and/or the storage of the files in the memory unit (1301) with the information, the owner user will have the opportunity to assign, through the assignment module (1020) one or more assigned users to share this information at the time of their death.

Each generated and/or stored file shall be individually assigned to an assigned user by means of the assignment module (1020).

Once the death of the main user is confirmed, the information stored in the memory (1301) for the main user and identified as assigned to an assigned user by the assignment module (1020) is transferred to the memory unit (1301) of the legacy life module (1100) corresponding to the assigned user.

Referring again to FIG. 1, the virtual vault system (1000) comprises a legacy wellness module (1400) configured to support the owner user in maintaining an adequate level of wellness in the 5 types of wellness: physical, mental, emotional, spiritual, and social.

The legacy wellness module (1400) is paired with a wearable device (7000) that is carried by the owner user and may also be synchronized with the user device (2000). The wearable device (7000) may be, but is not limited to, a smart watch, a smart band, a smart ring. The wearable device (7000) is configured to measure biometric parameters such as: heart rate, heart rate, temperature, user location, user speed, user movement, among others. The legacy wellness module (1400) is further configured to set by default the baseline parameters of the main user, according to physical and mental medical terms recommended by the World Health Organization; however, these parameters can be set and configured manually, via the user device (2000) by the main user in the legacy wellness module (1400), in a section of the invention that will have listed points to measure and recommended parameters, and the main user can choose at will their parameters in the units of measurement indicated by the World Health Organization. This module (1400), as mentioned above, will allow connection with devices such as bracelets and smart watches (7000), which communicate via Bluetooth connection, in order to keep a record of activity and physical condition and encourage the use of the application by means of notifications. The wellness legacy module (1400) is also configured to store advices, recommendations and/or incentives for award users to maintain a healthy lifestyle that can beneficially infer the 5 types of wellness, and most importantly share all these experiences with the designated persons upon death. All this by capturing a text, video or voice recording and uploading a file by loading it into a memory unit (1401) of the wellness legacy module (1400). The wellness legacy module (1400) further comprises a generation module (1410) configured to allow the main user to generate content that they wish their loved ones to be aware of and remember, such content can be generated in any of the aforementioned document formats and stored in the memory unit (1401). In this module (1400) are integrated the functionalities for understanding information generated or discharged in the invention, as described above, to feed the artificial intelligence, which will programmatically request information and incentives for the generation of this content or information by means of notifications with suggestions for content to be uploaded or in general. Text files, images, PDF, voice, video, experiences, etc., can be integrated in an enunciative but not limiting way. Either at the time of generation, through the generation module (1410) and/or the storage of the files in the memory unit (1401) with the information, the owner user will have the opportunity to assign, through the assignment module (1020) one or more assigned users to share this information at the time of his death.

Each generated and/or stored file shall be individually assigned to an assigned user by means of the assignment module (1020).

Once the death of the main user is confirmed, the information stored in the memory (1401) for the main user and identified as assigned to an assigned user by the assignment module (1020) is transferred to the memory unit (1401) of the wellness legacy module (1400) corresponding to the assigned user.

Referring again to FIG. 1, the virtual vault system (1000) comprises a knowledge module (1500) configured to store and generate initial user information that are of high utility. This knowledge module (1500) is further configured to integrate shortcuts for downloading mobile applications, sites and other technological tools that may be useful to make life easier. It will also be possible to store contact information of service providers, such as telephone, email, social network or work profile, address, etc. All this information is stored in a memory unit (1501) of the knowledge module (1500) to be able to have a contact control to cover day to day needs of the main users and their assigned users once the main user has died. This is done by capturing a text, video or voice recording and uploading a file by loading it into a memory unit (1501) of the knowledge module (1500). The knowledge module (1500) further comprises a generation module (1510) configured to allow the main user to generate content that they wish their loved ones to know and remember, such content can be generated in any of the aforementioned document formats and stored in the memory unit (1501). This module (1500) integrates the functionalities for the understanding of the information generated or discharged in the invention, as described above, to feed the artificial intelligence, which will programmatically request information and incentives for the generation of this content or information by means of notifications with suggestions for content to be uploaded or general. Text files, images, PDF, voice, video, experiences, etc., can be integrated in an enunciative but not limiting way. Either at the time of generation, through the generation module (1510) and/or the storage of the files in the memory unit (1501) with the information, the owner user will have the opportunity to assign, through the assignment module (1020) one or more assigned users to share this information at the time of his death.

Each generated and/or stored file shall be individually assigned to an assigned user by means of the assignment module (1020).

Once the death of the main user is confirmed, the information stored in the memory (1501) for the main user and identified as assigned to an assigned user by the assignment module (1020) is transferred to the memory unit (1501) of the knowledge module (1500) corresponding to the assigned user.

Referring again to FIG. 1, the virtual vault system (1000) comprises a maximum security vault module (1600) configured to replicate each of the sections that make up the previous modules (1100, 1200, 1300, 1400, 1500), as well as generate and/or store its own specific information, with the major difference that further validations will be required from the main user such as the generation of a temporary PIN that will be sent to the pre-configured point of contact (Email, WhatsApp, SMS, etc.), via a validation module (1630) to the user device (2000), which will request a password or validation from the main user via the user device (2000), which can be done by entering a password or validation to the user device (2000), which will request a validation from the main user via the user device (2000), via a validation module (1630) to the user device (2000), which will request a password or validation from the main user via the user device (2000), such validation can be done by entering a password in the user device (2000), such password is sent to the validation module (1630) for authentication, or such validation can be done by sending biometric data identified by the user device (2000) to the validation module (1630) for authentication. The maximum-security vault module (1600) is further configured so that upon confirmation of the death of the main user, the information contained in the memory unit (1601) is transferred exclusively with the one or more users assigned to know such information, if any, and thereafter the information contained in the memory unit (1601) is permanently deleted from the servers. Additionally, the highly secure vault module (1600) is configured to, upon confirmation of the death of the main user, terminate or block access to the main user's account to the virtual vault system (1000).

The maximum security vault module (1600) is configured to store, in a memory unit (1601), and/or generate information, by means of a generation module (1610), by means of text, sound or video capture or by means of uploading files that may be stored in the memory unit (1601) and may be entered directly into the memory unit (1601) of this module (1600) or are entered into the legacy of fife (1100), legacy financial (1200), legacy social (1300), legacy wellness (1400), legacy of knowledge (1500) modules by the user in an order that is easily located for later reference, financial legacy (1200), social legacy (1300), wellness legacy (1400), and knowledge legacy (1500) modules by the user in an order in which they can be easily located for later reference and in which the functionalities are optimal for storage and/or generation.

On the other hand, the maximum security vault module (1600) incorporates the configurations of the previous modules (1100, 1200, 1300, 1400, 1500), but with a double validation of the person, through the generation of a PIN of up to 6 characters that will be sent by the validation module (1630) by email or SMS to the user device (2000), in addition to having previously validated their password or biometric reading in order to access the information stored in this module (1600). This validation is done through the user device (2000) of the main user by registering a password, biometric recognition (facial recognition, iris recognition and/or fingerprint reading, depending on the capabilities of the equipment wherein the invention is executed) and a point of sending information in which a 6-digit PIN will be sent, which is generated automatically and randomly by the validation module (1630) once the first validation has been passed, in parallel, a capture field will be opened in a user interface of the user device (2000) wherein the 6-digit PIN will be entered and sent to the validation module (1630) for authentication, and in case the 6-digit PIN matches the PIN previously generated and sent by the validation module (1630) to the user device (2000), the main user will be granted access, through the user device (2000), to the maximum security vault module (1600).

In this high security vault module (1600) of the virtual vault system (1000), information initially aggregated in the other modules (1100, 1200, 1300, 1400, 1500) or directly to this module can be integrated. For all modules (1100, 1200, 1300, 1400, 1500, 1600) comprising the virtual vault system (1000), all information can be assigned to one or more users assigned via the assignment module (1020) by the Master user.

As part of the special features of the virtual vault system (1000), the information can be assigned to one or different persons by selecting Assigned users from the file registration or from the scanning of the stored files; the information will not be permanently deleted unless the assigned users decide not to maintain their license fee, nor will any information be taken or provided to other platforms (such as market segmentation, socio-economic level, points of contact, etc.).

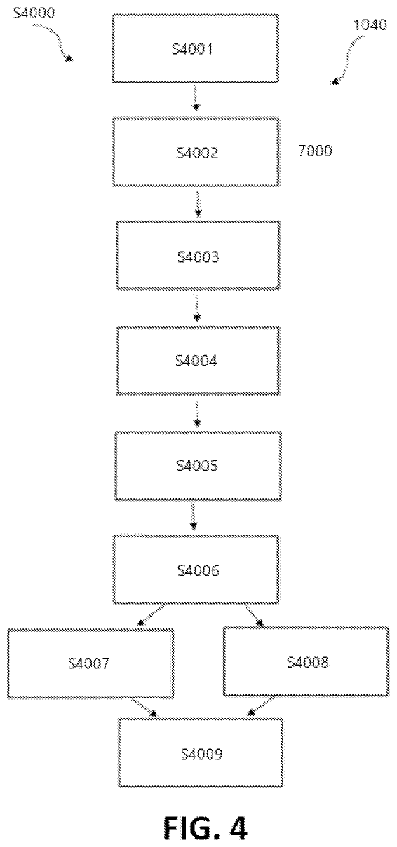

Referring now to FIG. 4, the virtual vault system (1000) comprises a death confirmation module (1040) that is configured to perform a death confirmation protocol of the owner user. In order to carry out the death confirmation protocol, it is necessary for the main user to configure from the death confirmation module (1040) his preferences for the protocol, which is done after his identity has been validated in the system (1000) by means of his username and password. In the death confirmation module (1040) the main user configures the time for the protocol execution, which consists of the time of inactivity within the application and communication with the gadgets (7000) that may be connected and linked to the system (1000) through the wellness legacy module (1400), as soon as this condition is met, contact is attempted, via the death confirmation module (1040) by Email or SMS, as configured in the module (1040), directly with the user device (2000) of the main user, if no response is received within 48 hours, the death confirmation module (1040) contacts via a service desk the Assigned users by the means configured in the death confirmation module (1040) (Email, SMS or phone call), if they confirm the death of the main user, the processes of release of information for sharing in the system itself (1000) to the assigned users shall be carried out, or, if applicable, deletion of the information that the main user has not assigned to assigned users and of the profile of the main user or owner or the preservation of the virtual vault in the system, in the metaverse, its avatar, etc.

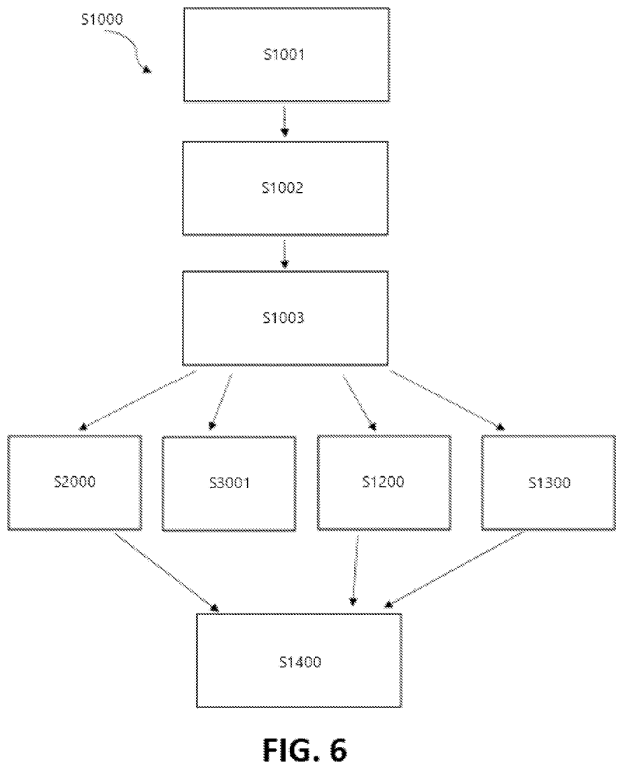

Referring now to FIG. 6, an alternative embodiment of the invention is described, wherein a method (S1000) is described for creating, storing, saving, storing, managing, tagging, collecting, organizing, assigning, sharing and/or transferring information by means of a highly secure virtual vault comprising a virtual vault system (1000) as the core of this invention and having the objective of providing a main user with safeguarding, in a memory unit (1101, 1201, 1301, 1401, 1501, 1601) of digital files, such as documents, images, photographs, videos, and recordings, including all types of life information that is generally lost, not stored, and not shared. The method comprises, an access step (S1001) of the main user to the virtual vault system (1000) from a main user device (2000), which may be, but is not limited to, a mobile phone, a tablet device, a personal computer or a laptop computer, or the metaverse and virtual vault itself.

To access the virtual vault system (1000), the main user registers (S1002) through the user device (2000) by filling in a form from a web portal or a mobile application of the system, or within the virtual vault system (1000) in a Metaverse (9000), the registration (S1002) is performed by entering their general contact details and registering a password and biometric data for future identity validation. This registration data is stored in a general memory unit (1001) of the virtual vault system (1000). The method further comprises forming (S1003) an activity database that is stored in the general memory unit (1001), whereby the context of the queries can be queried. Also considered in the registration process is the opportunity to acquire a license for the full or partial use of the invention. As part of the registration, the method comprises an assignment step (S2000), which is carried out by means of an assignment module (1020) of the virtual vault system (1000), wherein the main user, via the user device (2000) will have the possibility to choose, either at that time or at a later time, the integration of assignment of other users of the virtual vault system (1000), add other users of the system (1000) over time or remove them, who may be assigned access to, or transfer by means of a user device (3000), any information recorded by the main user in the virtual vault system (1000), or restrict or delete it, either in general or individually for each assigned user. In addition, the main user, by means of the user device (2000), may repeat the assignment step (S2000) to choose more than one assigned user.

The assignment stage (S2000) aims to maintain the elevated level of security between users, and is performed by an assignment module (1020). The assignment stage (S2100) comprises assigning (S2001), by the main user, one or more assigned users, and providing a validation process (S2201) of the assigned user personality through the process described in FIG. 2. This is done by means of the user devices (2000, 3000) and the assignment module (1020), registering (S2002) an assigned user account by the main user, entering the general data and contact data of the assigned user, which are stored in the general system memory (1001). Based on the data entered by the main user corresponding to the assigned user, the main user selects (S2002) a point of contact and generates (S2003) one or more data to be validated by the assigned user. Once the registration or registration of the assigned user by the owner user is completed, the method further comprises sending (S2004), via the assignment module (1020), an invitation to the assigned user device (3000), to validate the registration of the assigned user, said invitation is received (S2005) and opened in the assigned user device (3000), placing (S2005) the validation data in a validation page of the virtual vault system (1000) and, if the validation is successful, activates (S2006) the option for the owner user to allocate information stored in the memory units (1101, 1201, 1301, 1401, 1501, 160) of the different modules (1100, 1200, 1300, 1400, 1500, 1600) of the virtual vault system (1000) corresponding to the main user that may be known to and transferred to the assigned user until the death of the owner user. If the validation is not successful, the process shall be repeated from step (S2003). In this way, once the death of the main user has been confirmed by means of, the information stored in the memory units (1101, 1201, 1301, 1401, 1501, 1601) by the main user in the virtual vault system (1000) is transferred to the memory units (1101, 1201, 1301, 1401, 1501, 1601) corresponding to the assigned user.

According to a further embodiment of the invention, the method (S1000) for creating, storing, storing, storing, managing, managing, tagging, collecting, organizing, assigning, sharing, and/or transferring information via a highly secure virtual vault provides access to the main user, via the main user device (2000), to the modules (1100, 1200, 1300, 1400, 1500, 1600) of the virtual vault system (1000) as shown in FIG. 6. The main user, with prior registration as explained above in step (S1002), can enter (S3001) to any of the modules (1100, 1200, 1300, 1400, 1500, 1600) of the virtual vault system (1000). This access by the main user will be unique and all material generated by the main user from the invention or stored therein will be encrypted as mentioned above and cannot be known by any unauthorized person through the assignment process (S2000) conducted by the assignment module (1020) as described above.

The method (S1000) for creating, storing, saving, managing, tagging, collecting, organizing, assigning, sharing, and/or transferring information via a highly secure virtual vault comprises a stage of storing information (S1200) in the various modules (1100, 1200, 1300, 1400, 1500, 1600) of the virtual vault system (1000). The information storing stage (S1200) comprises storing information including, but not limited to, audio files, photographic files, video files, text files, personal information, classified information, confidential information, by capturing a text, a video or voice recording, and uploading a file by uploading the same, via a user device (2000), to a memory unit (1101, 1201, 1301, 1401, 1501, 1601) of any of the modules (1100, 1200, 1300, 1400, 1500, 1600) of the virtual vault system (1000).

The method (S1000) for creating, storing, saving, managing, tagging, collecting, organizing, assigning, sharing and/or transferring information via a highly secure virtual vault comprises a step of generating information (S1300), by a generation module (1110, 1210, 13010, 1410, 15010, 1610) of the modules (1100, 1200, 1300, 1400, 1500, 1600) of the virtual vault system (1000) so that the main user can generate content that they wish their loved ones to know about for their memories, which content can be generated in any of the above-mentioned document formats and stored in the memory unit (1101, 1201, 1301, 1401, 1501, 1601). At this stage of information generation (S1300), including but not limited to text, image, PDF, voice, video, experience, etc., files can be generated.

The method (S1000) for creating, storing, saving, managing, tagging, collecting, organizing, assigning, sharing and/or transferring information via a highly secure virtual vault comprises a file allocation stage (S1400) that occurs either at the time of the generation stage (S1300), via the generation module (1110, 1210, 1310, 1410, 1510, 1610) and/or the storage stage (S1200) of the files in the memory unit (1102, 1201, 1301, 1401, 1501, 1601) with the information, the owner user, via the user device (2000) will have the opportunity to assign, via the assignment module (1020) one or more assigned users to share this information at the time of his or her death.

Each generated and/or stored file shall be individually assigned to an assigned user by means of the assignment module (1020).

In a further embodiment of the invention, now referring to FIG. 4, the method (S1000) for creating, storing, saving, managing, tagging, collecting, organizing, assigning, sharing and/or transferring information via a highly secure virtual vault comprises a death confirmation process (S4000), which is carried out by a death confirmation module (1040). The death confirmation process (S4000) comprises a series of stages to perform a death confirmation protocol of the owner user. In a first step (S4001) of the death confirmation process (S4000), it is necessary for the main user to configure from the death confirmation module (1040) his preferences for the protocol, which is done after his identity has been validated in the system (1000) by means of his username and password. In the death confirmation module (1040) the main user configures the time for the execution of the protocol, which consists of the time of inactivity within the application and communication with the Gadgets (7000) that may be connected and linked to the system (1000) through the wellness legacy module (1400), as soon as this condition is fulfilled (S4002), the death confirmation process (S4000) comprises the step of attempting (S4003) to contact, via the death confirmation module (1040) by mail or SMS, as configured in the module (1040), directly the user device (2000) of the main user, in case no response is received within 48 hours, the process includes a step (S4004) that repeats the process of attempting to contact the user from step (S4003), and in case of no response within 48 hours, the death confirmation process (S4000) includes a step (S4005), to contact the assigned users by the means configured in the death confirmation module (1040) (Email, SMS or phone call) via a service desk, if they confirm the death of the main user (S4006), by means of the death confirmation module (1040), the stage (S4007) of releasing information for sharing in the system itself (1000) to assigned users will be carried out, or if applicable the stage of deletion (S4008) of the information that the lead user has not assigned to assigned users and of the lead user or owner profile or the preservation of the virtual vault in the system, in the metaverse, its avatar, etc. will be carried out. Once the step (S4007) of releasing information to assigned users has been completed, the death confirmation process further comprises a step (S2009) of sending notifications to assigned users.

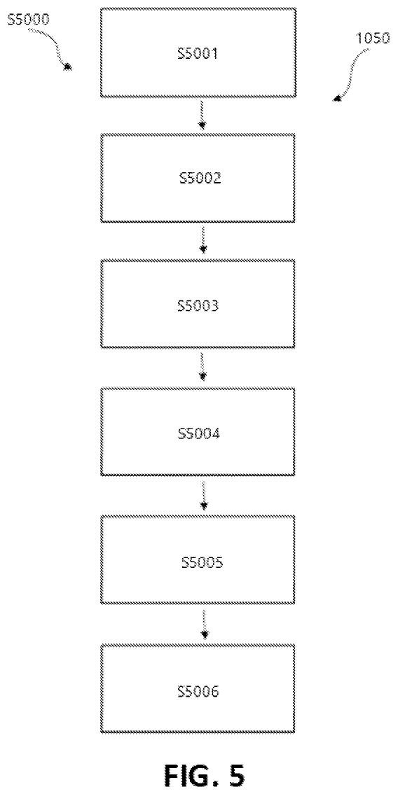

Referring now to FIG. 5, the virtual vault system (1000) comprises an artificial intelligence module (1050) configured to perform a data feed process for artificial intelligence (S5000). When the main user performs (S5001), via the user device (2000), the activation of the artificial intelligence module (1050) in the preference module of the virtual vault system (1000), the generation (S5002) of a table in the database stored in the corresponding Blockchain Array Server instance of the user is performed. An analysis (S5003) of the information uploaded or generated within the invention is carried out, by means of the upload or generation suggestions, the writing logic, voice sound, expression logic, gesticulation and body language will be obtained, depending on whether a text, voice or video file was uploaded or generated by the user owner. As a product of the analysis, the data is obtained, segmented and stored (S5004) in the artificial intelligence database. Once the data has been saved, the missing data is analyzed (S5005) to improve the performance of artificial intelligence. With the result of this analysis, a new suggestion for capturing or uploading files to the owner user is detonated (S5006).

An objective of the virtual vault system (1000) is to be able to replicate the way a lead user answers questions from an assigned user, replicate the lead user's writing style and logic, as well as capture and reproduce the voice and allow the use of images, videos and photographs of the lead user to obtain through image recognition, gesticulation, under certain situations, such as but not limited to, pressure, worry, stress, happiness, joy, laughter, anger, etc., including orderly interaction between the avatar or android and one or more users, including ordered interaction between the avatar or android and one or more users. All of the above is conducted by means of an artificial intelligence and avatar module (1060) of the virtual vault system (1000).

The information for this will be defined by the minimum requirements of the data required to be able to replicate, this will be defined by means of an investigation of requirements with which other artificial intelligences have demonstrated minimum performance. This will be supported by the push notifications of the invention and recommending the recording of video or voice messages, the answering of the question in written form and finally the choice of the image with which the main user wishes to be remembered by the assigned users who will have access to this information, which may include teaching and learning by the user on a daily basis, which is only possible by the user owners themselves who will eventually deliver, share and interact with their essence and other user(s). Access will be through a general module (1060) that will be integrated with the base modules (1100, 1200, 1300, 1400, 1500, 1600) of the virtual vault system (1000).

This artificial intelligence module (1060) will have a space within the Block Server Array due to the privacy of the data that conforms it, thus allowing access to the data only and exclusively by the connection from the platform object of this invention.

The artificial intelligence module (1060) will use the information hosted in the memory units (1101, 1201, 1301, 1401, 1501, 1601) of the modules (1100, 1200, 1300, 1400, 1500, 1600) of the virtual vault system (1000) to perform the relevant analysis of the script logic, the answer to the generated questions and will be delivered via a chat interface on the user devices (3000) with which the assigned users will encounter as part of the artificial intelligence module (1060).

Similarly, the artificial intelligence module (1060) will have access to a voice chat, through the user device (3000) wherein the assigned user will be able to capture questions through audio input and output devices arranged in the user device (3000), through the process of voice recognition and based on what is learned textually and what is captured through voice, the artificial intelligence module (1060) will respond with interactions of the owner user or of the authorized user or users. Using the artificial intelligence module (1060) as access location, the main user will be able to configure by means of photographs and images of himself, what will be the appearance of his avatar, which will be able to make an imitation of gestures and gestures which will be recognized thanks to the recording of videos and analyzed by the artificial intelligence. This option of use will have 2 methods of interaction with the user, the first being represented by a close-up of the avatar's face, wherein it can be observed from the area of the shoulders to the highest point of the head and a second full body version which will also be configurable by means of a graphic interface to which the owner user will have access and will be able to adapt as many times as he/she wishes. This full body avatar will reside within an environment called metaverse.

In the virtual vault system (1000), by means of the user device (2000), the main user will be able to extend his user license to introduce the avatar to a virtual world which will be hosted in the Block Server Array and which will be accessible with the user and password of the invention, by means of a metaverse module (1070). This metaverse will include access to the virtual vault, by means of a virtual entrance, this being represented as a true representation of a bank vault. In this metaverse it will be possible to sell and/or rent, as well as design and/or construct spaces for the placement of virtual buildings such as sports facilities, cinemas, work buildings, malls, meeting rooms, etc.

Through the metaverse module (1070), the system (1000) generates an imitation of the streets and buildings and other infrastructure of a real-life city in a virtual world but is being made accessible only by devices with the ability to access, graphically reproduce these spaces.

1.-23. (canceled)

24. A virtual vault system (1000) for creating, storing, saving, managing, tagging, collecting, organizing, assigning, sharing and/or transferring information between users, comprising:
a plurality of modules (1100, 1200, 1300, 1400, 1500, 1600) configured to generate and/or store information;
a general memory unit (1001) of the virtual vault system (1000), configured to store general data of a user and event logs of that user;
an assignment module (1020) configured to assign, by the main user, one or more assigned users;
a death confirmation module (1040) configured to perform a user death confirmation protocol;
an artificial intelligence module (1050) configured to perform a data feed process for the artificial intelligence.
characterized in that the system is configured to transfer the information of a main user contained in modules (1100, 1200, 1300, 1400, 1500, 1600) to modules (1100, 1200, 1300, 1400, 1500, 1600) of an assigned user once the confirmation module (1040) confirms the death of the main user;
wherein the plurality of modules comprises a wellness legacy module (1400), comprising a memory unit (1401) configured to store main user information, and a generation module (1410) configured to generate main user information;
wherein the system further comprises an artificial intelligence and avatar module (1060) configured to replicate the manner of giving answers of a main user to questions of an assigned user, replicate the typing style and logic of the main user, as well as capture and reproduce the voice of the main user; and
wherein the system further comprises a metaverse module (1070) configured to generate an imitation of the streets and buildings and other infrastructure of a real-life city in a virtual world.

25. The virtual vault system (1000) according to claim 24, wherein the main user logs into the system (1000) via a user device (2000).

26. The virtual vault system (1000) according to claim 24, wherein the plurality of modules comprises a legacy life module (1100), comprising a memory unit (1101) configured to store main user information, and a generation module (1110) configured to generate main user information.

27. The virtual vault system (1000) according to claim 24, wherein the plurality of modules comprises a financial legacy module (1200), comprising a memory unit (1201) configured to store main user information, and a generation module (1210) configured to generate main user information.

28. The virtual vault system (1000) according to claim 24, wherein the plurality of modules comprises a social legacy module (1300), comprising a memory unit (1301) configured to store main user information, and a generation module (1310) configured to generate main user information.

29. The virtual vault system (1000) according to claim 24, wherein the plurality of modules comprises a knowledge module (1500), comprising a memory unit (1501) configured to store main user information, and a generation module (1610) configured to generate main user information.

30. The virtual vault system (1000) according to claim 24, wherein the plurality of modules comprises a maximum-security vault module (1600), comprising a memory unit (1601) configured to store main user information, and a generation module (1610) configured to generate main user information.

31. The virtual vault system (1000) according to claim 24, wherein the wellness legacy module (1400) is configured to couple with an external device (7000) to obtain biometric parameters of the user.

32. The virtual vault system (1000) according to claim 24, wherein the artificial intelligence and avatar module (1060) is configured to generate an avatar of a main user that may be viewed on a user device (3000) corresponding to an assigned user.

33. A method for creating, storing, saving, managing, tagging, collecting, organizing, assigning, sharing, and/or transferring information via a highly secure virtual vault, the method comprising:
a main user access step (S1001) to a virtual vault system (1000) from a user device (2000);
a registration step (S1002) in the virtual vault system (1000) via the user device (2000);
a forming step (S1003) of an activity base in a general memory unit (1001);
an assignment step (S2000), which is performed by an assignment module (1020), to assign, by the main user, one or more assigned users;
a death confirmation step (S4000), which is performed by a death confirmation module (1040), to perform a user death confirmation protocol;
characterized in that if the death of the user is confirmed in step (S4000), the method comprises an information release step (S4007) to share information from the main user to the assigned users;
wherein the registering step (S1002) further comprises entering, via the user device (2000), general user contact data and recording a password and biometric data for future identity validations; wherein this registration data is stored in a general memory unit (1001) of the virtual vault system (1000); and
wherein after confirming the death of the main user in step (S4006), the method comprises deleting (S4008) all files that do not have an assigned user from the virtual vault system (1000) corresponding to the main user.

34. The method according to claim 33, wherein the registering step (S1002) comprises performing, from a user device (2000), a registration by filling out a form from a web portal or a mobile application of the system, or within the system (1000) virtual vault system in a Metaverse (9000).

35. The method according to claim 33, wherein the assigning step (S2000) further comprises assigning (S2001), by the main user, one or more assigned users, and providing a validation process for the assigned user personality.

36. The method according to claim 33, wherein the method further comprises a step of entry (S3001) by the user, via a user device (2000), to any one of the modules (1100, 1200, 1300, 1400, 1500, 1600) of the virtual vault system (1000).

37. The method according to claim 33, wherein the method further comprises a step of storing information (S1200) in the various modules (1100, 1200, 1300, 1400, 1500, 1600) of the virtual vault system (1000).

38. The method according to claim 33, wherein the method further comprises a step of generating information (S1300), by a generating module (1110, 1210, 13010, 1410, 15010, 1610) from the modules (1100, 1200, 1300, 1400, 1500, 1600) of the virtual vault system (1000).

39. The method according to claim 37, wherein the method further comprises a file allocation stage (S1400) that takes place either at the time of the generating stage (S1300), by means of the generating module (1110, 1210, 1310, 1410, 1410, 1510, 1610) and/or the storage stage (S1200) of the files in the memory unit (1102, 1201, 1301, 1401, 1501, 1601) with the information, the owner user, via the user device (2000) can assign, via the assignment module (1020), one or more assigned users to share this information at the time of his or her death.

40. The method according to claim 38, wherein the method further comprises a file allocation stage (S1400) that takes place either at the time of the generating stage (S1300), by means of the generating module (1110, 1210, 1310, 1410, 1410, 1510, 1610) and/or the storage stage (S1200) of the files in the memory unit (1102, 1201, 1301, 1401, 1501, 1601) with the information, the owner user, via the user device (2000) can assign, via the assignment module (1020), one or more assigned users to share this information at the time of his or her death.

41. The method according to claim 33, wherein the step of confirming death (S4000) further comprises:
configure (S4001), from the death configuration module (1040) by means of a user device (2000), user preferences;
attempting contact (S4003), via the death module (1040) with the main user after a condition (S4002) has been met, via the user device (2000);
contact (S4005), via the death confirmation module (1040), to assigned users, through user devices (3000), by the means configured in the death confirmation module (1040);
once the death of the main user (S4006) is confirmed, release the information (S4007) of the main user for sharing in the virtual vault system (1000) with the assigned users; and
send a notification (S4009) to the assigned users once the information release step (S4007) has been conducted.
